(19) United States
(12) Patent Application Publication
(10) Pub. No.: US 2008/0229382 A1
(43) Pub. Date: Sep. 18, 2008

(54) MOBILE ACCESS TERMINAL SECURITY FUNCTION

(75) Inventor: Christopher L. Vitalos, Washington, NJ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/685,882

(22) Filed: Mar. 14, 2007

(51) Int. Cl. H04L 9/00

(52) U.S. Cl. 726/1

(57) ABSTRACT

Provided are a method, wireless communication device, and wireless communications system for managing packet data transmissions. The method includes receiving a set of security policies (126) from a service provider. A request from an application (124) is received to originate packet data. The set of security policies (126) provided by the service provider is analyzed in response to receiving the request to originate packet data. The method also includes determining, in response to the analyzing, if the set of security policies (126) allows the packet data to be transmitted. In response to the set of security policies (126) allowing the packet data to be transmitted, the packet data is allowed to be transmitted onto a wireless network (102). In response to the set of security policies (126) not allowing the packet data to be transmitted, the packet data from is prevented from being transmitted onto a wireless network (102).

### FIELD OF THE INVENTION

The present invention generally relates to the field of wireless communications, and more particularly relates to monitoring and managing outbound packets of a wireless device for the prevention of malicious behavior.

### BACKGROUND OF THE INVENTION

As mobile telephony networks evolve to utilize IP technologies, they will become increasingly vulnerable to denial of service attacks. Elements within the system i.e. mobile stations can either become the targets of the attack, or can become agents to launch an attack via use of “trojan horses”. There are current products called reverse firewalls that are implemented in personal computers. Reverse firewalls control the outbound or egress IP traffic from suspect applications. One problem with reverse firewalls is that the end user is required to maintain these applications in order for them to be effective.

Reverse firewalls are also implemented in traditional IP networks that mostly include general purpose computers. These installations assist corporate administrators and/or end users in ensuring the secure functioning and appropriate use of the general purpose computers. As discussed above, these reverse firewalls typically require the end user to configure a security policy i.e. determine which network traffic is allowed or disallowed transmission. Requiring the end user to maintain this configuration in the mobile access terminals is impractical. Also, this current methodology does not accommodate the network operators' need for dictating security policies at the access terminal end points.

Additionally, these systems only allow device and user based authentication. After the mobile device and user is authenticated to the network, data sessions are only supervised based on usage criteria. There is no screening for malicious behavior which accommodates the end user's subscription information and operator's security policy. Also, no functionality exists to isolate mobile traffic in such a way that would prevent malicious traffic from being transmitted on the radio access network.

Also, as mobile phone technology increasingly allows for the end user to install and run applications which may not be necessarily distributed from the carrier providing service, the mobile telephone operator needs a mechanism to disallow unrecognized applications from running on remote mobile phones. This is to prevent potentially harmful applications from originating malicious packets onto the network.

Therefore a need exists to overcome the problems with the prior art as discussed above.

### SUMMARY OF THE INVENTION

Briefly, in accordance with the present invention, disclosed are a method, wireless communication device, and wireless communications system for managing packet data transmissions. The method includes receiving a set of security policies from a service provider. A request from an application is received to originate packet data. The set of security policies provided by the service provider is analyzed in response to receiving the request to originate packet data. The method also includes determining, in response to the analyzing, if the set of security policies allows the packet data to be transmitted. In response to the set of security policies allowing the packet data to be transmitted, the packet data is allowed to be transmitted onto a wireless network. In response to the set of security policies not allowing the packet data to be transmitted, the packet data from is prevented from being transmitted onto a wireless network.

In another embodiment, a wireless communications device for managing packet data transmissions is disclosed. The wireless communications device includes a memory and a processor that is communicatively coupled to the memory. The wireless communications device also includes a security module that is communicatively coupled to the memory and the processor. The security module is adapted to receiving a set of security policies from a service provider. A request from an application is received to originate packet data. The set of security policies provided by the service provider is analyzed in response to receiving the request to originate packet data. The security module also determines, in response to the analyzing, if the set of security policies allows the packet data to be transmitted. In response to the set of security policies allowing the packet data to be transmitted, the packet data is allowed to be transmitted onto a wireless network. In response to the set of security policies not allowing the packet data to be transmitted, the packet data from is prevented from being transmitted onto a wireless network.

In yet another embodiment a wireless communications system for managing packet data transmissions is disclosed. The wireless communications system comprises a plurality of base stations and a plurality of wireless communications devices. Each wireless communication device is communicatively coupled to at least one base station. At least one wireless communication device includes a security module that is adapted to receiving a set of security policies from a service provider. A request from an application is received to originate packet data. The set of security policies provided by the service provider is analyzed in response to receiving the request to originate packet data. The security module also determines, in response to the analyzing, if the set of security policies allows the packet data to be transmitted. In response to the set of security policies allowing the packet data to be transmitted, the packet data is allowed to be transmitted onto a wireless network. In response to the set of security policies not allowing the packet data to be transmitted, the packet data from is prevented from being transmitted onto a wireless network.

One of the advantages of the present invention is that malicious behavior originating at a mobile device can be prevented via the service provider. This security function resident can be resident in both the mobile device and network components. Another advantage of the present invention is that the mobile device user does need to maintain security policies, but are maintained by the by network operator. This allows for the network operator to control the applications running on mobile devices remotely. Therefore, the present invention empowers mobile network operators to maintain control of IP network traffic, and isolate offending mobile devices from their networks.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communications systems according to an embodiment of the present invention;

FIG. 2 is a block diagram illustrating a wireless communication device according to an embodiment of the present invention;

FIG. 3 is a block diagram illustrating a information processing system according to an embodiment of the present invention;

FIG. 4 is an operational flow diagram illustrating a process of initializing a wireless device for security functions according to an embodiment of the present invention;

FIG. 5 is an operational flow diagram illustrating a process of managing wireless device security events via a security module at a wireless device according to an embodiment of the present invention;

FIG. 6 is an operational flow diagram illustrating continuing the process of FIG. 5;

FIG. 7 is an operational flow diagram illustrating a process of screening application events via a security module at a wireless device according to an embodiment of the present invention;

FIG. 8 is an operational flow diagram illustrating a process of screening packets originating at a wireless device via a security module 120 at the wireless device according to an embodiment of the present invention;

FIG. 9 is an operational flow diagram illustrating a process of initializing a security module residing at an information processing system according to an embodiment of the present invention;

FIG. 10 is an operational flow diagram illustrating process of managing security events via a security module residing at an information processing system according to an embodiment of the present invention;

FIG. 11 is an operational flow diagram continuing the process of FIG. 10; and

FIG. 12 is an operational flow diagram illustrating a process of quarantining a wireless device via a security module residing at an information processing system according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communications System

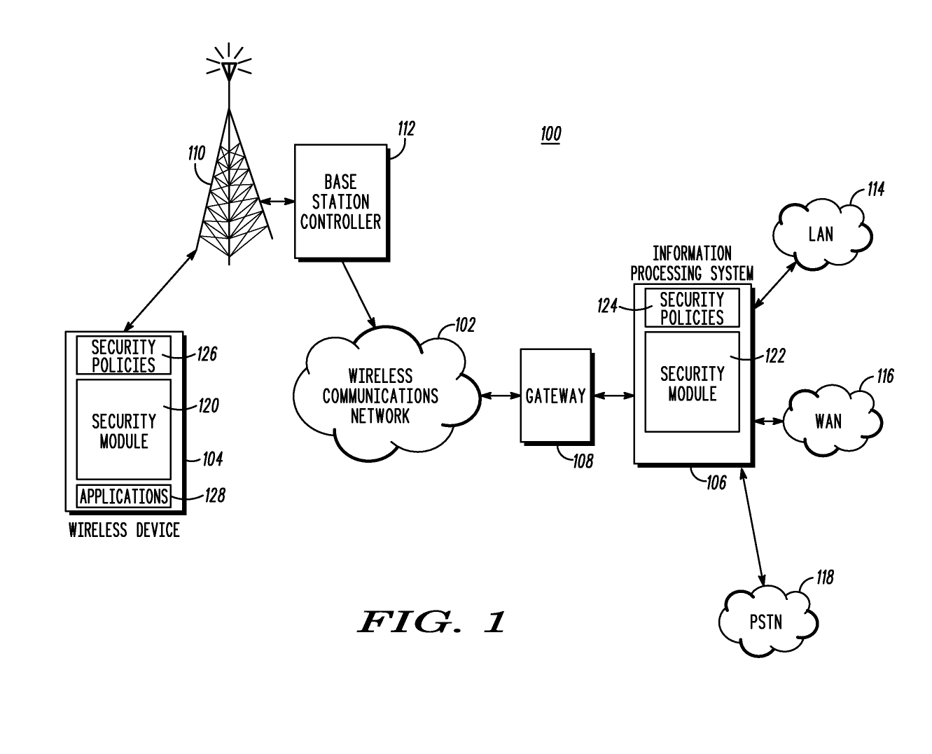

According to an embodiment of the present invention, as shown in FIG. 1, an exemplary wireless communications system 100 is illustrated. FIG. 1 shows a wireless communications network 102 that connects one or more wireless devices 104 with an information processing system such as a central server 106 via a gateway 108. The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Wireless LAN (WLAN), WiMAX or the like. Additionally, the wireless communications network 102 also supports text messaging standards, for example, Short Message Service (SMS), Enhanced Messaging Service (EMS), Multimedia Messaging Service (MMS), or the like. The wireless communications network 102 also allows for PoC communications between the wireless devices 104, 106, 108.

The wireless network 102 supports any number of wireless devices 104. The wireless communication device 104 can be either a multi-mode device or a single mode device. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities supporting additional communication services.

Additionally, the wireless device 104 can also include a local wireless link (not shown) that allows the wireless device 104 to directly communicate with each other without using the wireless network 102. The local wireless link (not shown), for example, can be used for PTT communications. The local wireless link (not shown), in another embodiment, is provided by Bluetooth, Infrared Data Access (IrDA) technologies or the like. The information processing system 106 maintains and processes information for all wireless devices communicating on the wireless network 102.

The wireless communications system 100 also includes one or more base stations 110 communicatively coupled to a base station controller 112. The wireless communication device 110, in this example, is communicatively coupled to the wireless communications network 102 via the base stations 110. Additionally, the information processing system 106, in this example, communicatively couples the wireless device 104 to a wide area network 114, a local area network 116, and a public switched telephone network 118 through 114, 116, 118 has the capability of sending data, for example, a multimedia text message to the wireless device 104.

The wireless device 104 and the information processing system 106, in one embodiment, each include a security module 120, 122. The security module 120 residing at the wireless device 104 can be referred to as the “mobile resident security module 120”. The security module 122 residing at the information processing system 106 can be referred to as the “network resident security module 122”.

It should be noted that although the security module 122 is shown residing within the information processing system 106, the security module 122 can reside within any network component or information processing system communicatively coupled to the wireless communications network 102. In one embodiment, the security modules 120, 122 are IP packet firewalls that can be implemented on IP network end points such as computers, fourth generation mobile phones, and the like. However, the security modules 120, 122 are not limited to IP packet firewalls or fourth generation mobile phones. These examples were used only for illustrative purposes.

Additionally, the mobile resident security module 120, in one embodiment, is designed such that it is not accessible by a user. The network resident security module 122 implements one or more security policies 124 into the wireless device 104. The mobile resident security module 120 screens outbound traffic based on resident security polices 126 (which have been implemented by the network resident security module 122) and allows or denies data sessions from being established.

In one example, the wireless device 104 obtains one or more security policies from its service provider. In one embodiment, the wireless device 104 is first authenticated by the wireless communications network 102. If the wireless device is authenticated, e.g., allowed service by the service provider, the location of the wireless device 104 is registered and the device 104 is allowed to received inbound sessions from the network 102. After being authenticated, the mobile reside security module 120, communicates with the information processing system 106 to obtain one or more security policies 126 from the service provider. The security policy 126 implemented on the wireless device 104, in one embodiment, is based on user subscription information and network operators security policy. Once the security policy 126 has been implemented on the wireless device 104, the mobile resident security module 120 is ready to filter outbound data sessions from itself toward the Internet Protocol (“IP”) network of the wireless communications network 102.

When an application 128 on the wireless device 104 attempts an outbound data session, the mobile resident security module 120 screens the session attempt based on one or more of the security policies 126 implemented on the device 104. If the mobile resident security module 120 determines that the requested data session is within the parameters of the security policy(s) 126, the mobile resident security module 120 allows the data session to be set up through mobile access terminal's IP stack (not shown), radio logic, resources, and the like to the network 102.

However, if the mobile resident security module 120 determines that the requested data session does not satisfy the security policy(s) 126, then the mobile resident security module 120 prevents the data session from being setup through the IP stack (not shown) and alerts the user of the device 104 and the network operator regarding the condition. The network resident security module 122 logs the denied access attempt. In one embodiment, a network operator can also change a security policy 126 implemented on a wireless device 104. For example, a network operator changes a security policy communicatively coupled to the network resident security module 122. For one or more of the wireless devices 104 that have been authenticated to the network 102 at the time of the change, the mobile resident security module 120 at the information processing system 106 updates all authenticated and registered wireless devices 104. In other words, the network resident security module 122 detects a new or modified security policy 124 on the network side and updates the security policy(s) 126 at the wireless device 104. For a wireless device that is not registered with the network 102, the security policy change is queued for distribution to the wireless device once it is registered.

In another embodiment, the mobile resident security module 120 of the wireless device 104 can also be updated by a network operator. For example, the network operator via the network resident security module 122 or via another mechanism transmits an update patch to the mobile resident security module 120. A wireless device 104 that is registered with the network 102 at the time of the change, is updated by the network resident security module 122 of the information processing system 106 based on scheduling parameters and wireless device 104 availability.

As can be seen, the present invention provides an advantageous system that allows a service provider to prevent malicious behavior at a wireless device from being performed on the network. Another advantage of the present invention is that the mobile device user does need to maintain security policies, but are maintained by the by network operator. This allows for the network operator to control the applications running on mobile devices remotely. Therefore, the present invention empowers mobile network operators to maintain control of IP network traffic, and isolate offending mobile devices from their networks.

Wireless Communication Device

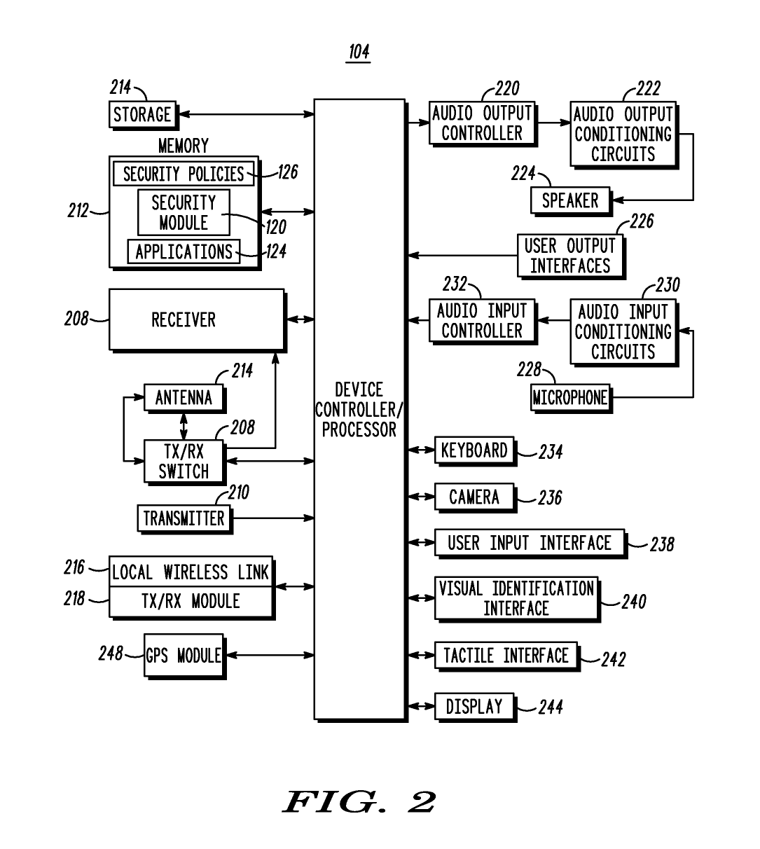

FIG. 2 is a block diagram illustrating a more detailed view of the wireless device 104. The wireless device 104 operates under the control of a device controller/processor 202, that controls the sending and receiving of wireless communication signals. In receive mode, the device controller 202 electrically couples an antenna 204 through a transmit/receive switch 206 to a transceiver 208. The transceiver 208 decodes the received signals and provides those decoded signals to the device controller 202.

In transmit mode, the device controller 202 electrically couples the antenna 204 through the transmit/receive switch 206 to the transceiver 208. The device controller 202 operates the transceiver according to instructions (not shown) stored in the memory 212. These instructions include, for example, a neighbor cell measurement-scheduling algorithm. The memory 212 also includes the security module 120 and security policies 126. In one embodiment, an application(s) 128 are also stored in the memory. The wireless device 104 also includes non-volatile storage memory 216. It should be noted that the one or more of the security module 120, security policies 126, and application(s) 128 can be included in the storage memory 216 as well.

The wireless device 104, in this example, also includes an optional local wireless link 218 that allows the wireless device 104 to directly communicate with another wireless device without using a wireless network (not shown). The optional local wireless link 218, for example, is provided by Bluetooth, Infrared Data Access (IrDA) technologies, or the like. The optional local wireless link 218 also includes a local wireless link transmit/receive module 220 that allows the wireless device 104 to directly communicate with another wireless communication device such as wireless communication devices communicatively coupled to personal computers, workstations, and the like.

The wireless device 104 of FIG. 2 further includes an audio output controller 222 that receives decoded audio output signals from the receiver 208 or the local wireless link transmit/receive module 220. The audio controller 222 sends the received decoded audio signals to the audio output conditioning circuits 224 that perform various conditioning functions. For example, the audio output conditioning circuits 224 may reduce noise or amplify the signal. A speaker 226 receives the conditioned audio signals and allows audio output for listening by a user. The audio output controller 222, audio output conditioning circuits 224, and the speaker 226 also allow for an audible alert to be generated notifying the user of a missed call, received messages, or the like. The wireless device 104 further includes additional user output interfaces 228, for example, a head phone jack (not shown) or a hands-free speaker (not shown).

The wireless device 104 also includes a microphone 230 for allowing a user to input audio signals into the wireless device 104. Sound waves are received by the microphone 230 and are converted into an electrical audio signal. Audio input conditioning circuits 232 receive the audio signal and perform various conditioning functions on the audio signal, for example, noise reduction. An audio input controller 234 receives the conditioned audio signal and sends a representation of the audio signal to the device controller 202.

The wireless device 104 also comprises a keyboard 236 for allowing a user to enter information into the wireless device 104. The wireless device 104 further comprises a camera 238 for allowing a user to capture still images or video images into memory 214. Furthermore, the wireless device 104 includes additional user input interfaces 240, for example, touch screen technology (not shown), a joystick (not shown), or a scroll wheel (not shown). In one embodiment, a peripheral interface (not shown) is also included for allowing the connection of a data cable to the wireless device 104. In one embodiment of the present invention, the connection of a data cable allows the wireless device 104 to be connected to a computer or a printer.

A visual notification (or indication) interface 242 is also included on the wireless device 104 for rendering a visual notification (or visual indication), for example, a sequence of colored lights on the display 246 or flashing one or more LEDs (not shown), to the user of the wireless device 104. For example, a received multimedia message may include a sequence of colored lights to be displayed to the user as part of the message. Alternatively, the visual notification interface 242 can be used as an alert by displaying a sequence of colored lights or a single flashing light on the display 246 or LEDs (not shown) when the wireless device 104 receives a message, or the user missed a call.

The wireless device 104 also includes a tactile interface 244 for delivering a vibrating media component, tactile alert, or the like. For example, a multimedia message received by the wireless device 104, may include a video media component that provides a vibration during playback of the multimedia message. The tactile interface 244, in one embodiment, is used during a silent mode of the wireless device 104 to alert the user of an incoming call or message, missed call, or the like. The tactile interface 244 allows this vibration to occur, for example, through a vibrating motor or the like.

The wireless device 104 also includes a display 246 for displaying information to the user of the wireless device 104 and an optional Global Positioning System (GPS) module 248 The optional GPS module 248 determines the location and/or velocity information of the wireless device 104. This module 248 uses the GPS satellite system to determine the location and/or velocity of the wireless device 104. Alternative to the GPS module 248, the wireless device 104 may include alternative modules for determining the location and/or velocity of wireless device 104, for example, using cell tower triangulation and assisted GPS.

Information Processing System

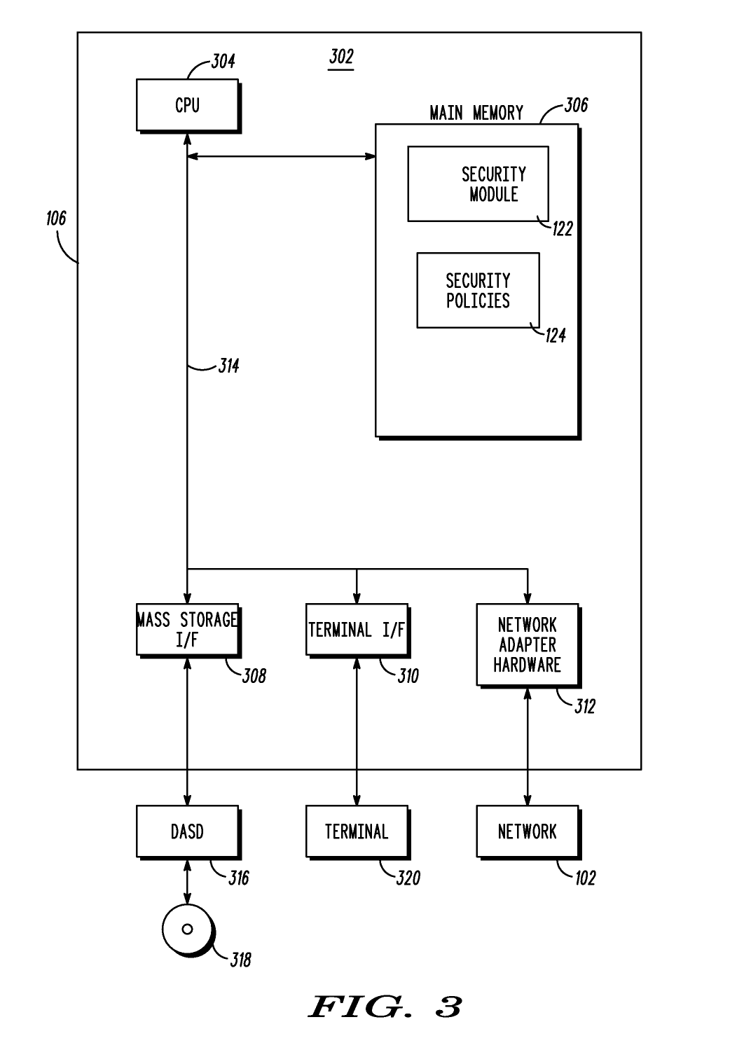

FIG. 3 is a block diagram illustrating a detailed view of the information processing system 106 according to an embodiment of the present invention. The information processing system 106, in one embodiment, is based upon a suitably configured processing system adapted to implement the exemplary embodiment of the present invention. Any suitably configured processing system is similarly able to be used as the information processing system 106 by embodiments of the present invention, for example, a personal computer, workstation, or the like.

The information processing system 106 includes a computer 302. The computer 302 has a processor 804 that is communicatively connected to a main memory 306 (e.g., volatile memory), non-volatile storage interface 308, a terminal interface 310, and a network adapter hardware 312. A system bus 314 interconnects these system components. The non-volatile storage interface 308 is used to connect mass storage devices, such as data storage device 316 to the information processing system 106. One specific type of data storage device is a computer readable medium such as a CD drive, which may be used to store data to and read data from a CD or DVD 318 or floppy diskette (not shown). Another type of data storage device is a data storage device configured to support, for example, NTFS type file system operations.

The main memory 306, in one embodiment, includes the security module 122 and security policies 124 discussed above. Although shown as residing in the memory 206, the security module 122 can be implemented in hardware within the information processing system 106. In one embodiment, the information processing system 106 utilizes conventional virtual addressing mechanisms to allow programs to behave as if they have access to a large, single storage entity, referred to herein as a computer system memory, instead of access to multiple, smaller storage entities such as the main memory 206 and data storage device 216. Note that the term “computer system memory” is used herein to generically refer to the entire virtual memory of the information processing system 106

Although only one CPU 204 is illustrated for computer 802, computer systems with multiple CPUs can be used equally effectively. Embodiments of the present invention further incorporate interfaces that each includes separate, fully programmed microprocessors that are used to off-load processing from the CPU 204. Terminal interface 210 is used to directly connect one or more terminals 220 to computer 202 to provide a user interface to the computer 202. These terminals 220, which are able to be non-intelligent or fully programmable workstations, are used to allow system administrators and users to communicate with the thin client. The terminal 220 is also able to consist of user interface and peripheral devices that are connected to computer 202 and controlled by terminal interface hardware included in the terminal I/F 210 that includes video adapters and interfaces for keyboards, pointing devices, and the like.

An operating system 222, according to an embodiment, can be included in the main memory 206 and is a suitable multitasking operating system such as the Linux, UNIX, Windows XP, and Windows Server 2001 operating system. Embodiments of the present invention are able to use any other suitable operating system, or kernel, or other suitable control software. Some embodiments of the present invention utilize architectures, such as an object oriented framework mechanism, that allows instructions of the components of operating system (not shown) to be executed on any processor located within the client. The network adapter hardware 212 is used to provide an interface to the network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 218, CD ROM, or other form of recordable media, or via any type of electronic transmission mechanism.

Process of Initializing a Wireless Device for Wireless Device Security Function

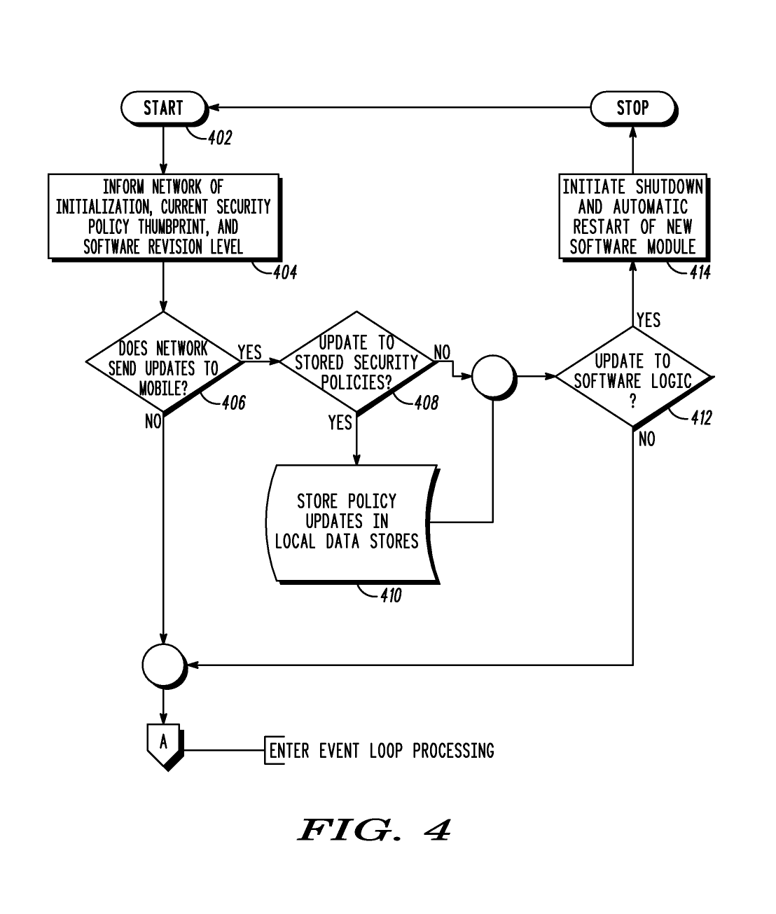

FIG. 4 is an operational flow diagram illustrating a process of initializing a wireless devices for the wireless device security function discussed above. In particular, FIG. 4 shows a mobile resident function starting its initialization routine by informing its peer network resident function of its start up status. The operational flow diagram of FIG. 4 begins at step 402 and flows directly to step 404. The mobile resident security module 120 at the wireless device 104, at step 904, informs the network 102 of initialization. The current security policy thumbprint (if any) and security software revision level is transmitted to the security module 122 of the information processing system 106. The security module 120, at step 406, determines if updates have been received from the security module 122 at the information processing system 106.

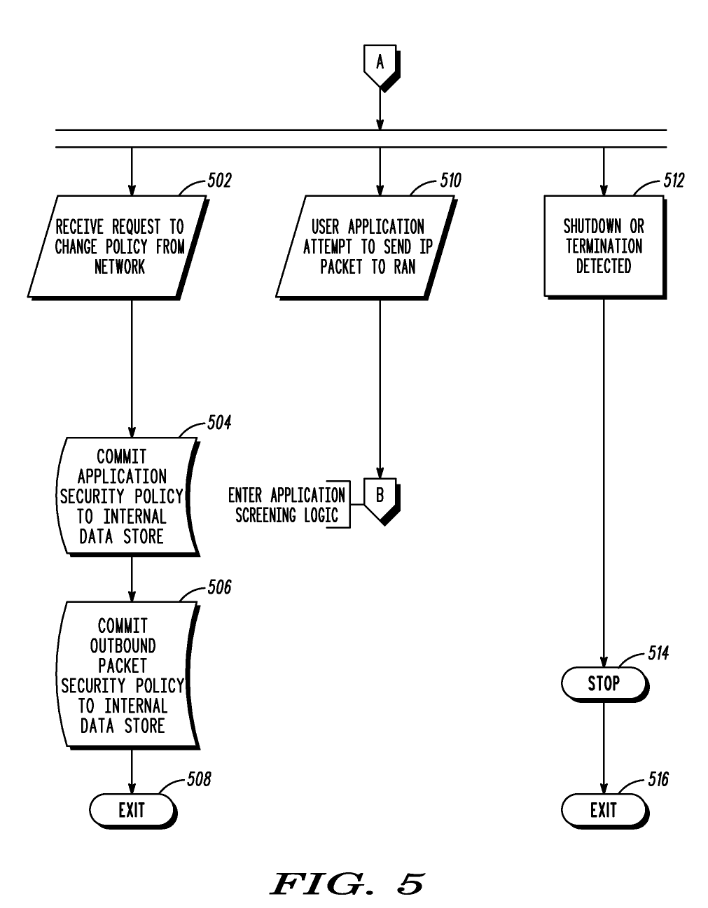

If the result of this determination is negative the control flows to entry point A of FIG. 5 (an event processing loop). If the result of this determination is positive, the security module 120, at step 408, determines whether the received updates are updates to stored security policies 126. If the result of this determination is positive, the mobile resident security module 120, at step 410, stores the policy updates to the local data store, e.g. memory 212, 216. The control then flows to step 412. If the result of this determination is negative, the mobile resident security module 120, at step 412, determines if the update is to the security module 120 itself. If the result of this determination is positive, the mobile resident security module 120, at step 414, initiates shutdown and automatically restarts the updated software module. The control flows returns to step 402. If the result of this determination is negative, the control flows to entry point A of FIG. 5.

Process of Managing Wireless Device Events Via the Security Module

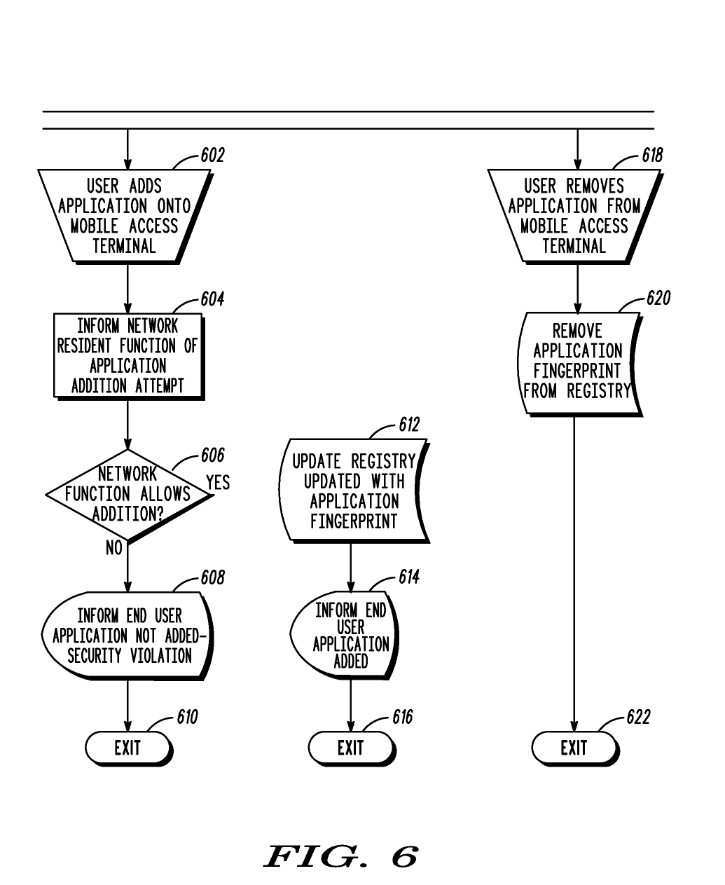

FIGS. 5 and 6 are operational flow diagrams illustrating a process of managing wireless device security events via the mobile resident security module 120 at the wireless device 104. The control flow of FIG. 5 enters at entry point A and flows directly to step 502. The mobile resident security module 120 at the wireless device 103, at step 502, receives a request from the network 102 to change a security policy 126. For example, the mobile resident security module 120 at the wireless device can receive a request to change a security policy 126 from the network resident security module 122 at the information processing system 106. The mobile resident security module 120, at step 504, commits application security policy(s) to an internal data store such as memory 212, 216. The mobile resident security module 120, at step 506, commits outbound packet security policy(s) to an internal data store such as memory 212, 216. The control flow then exits at step 508.

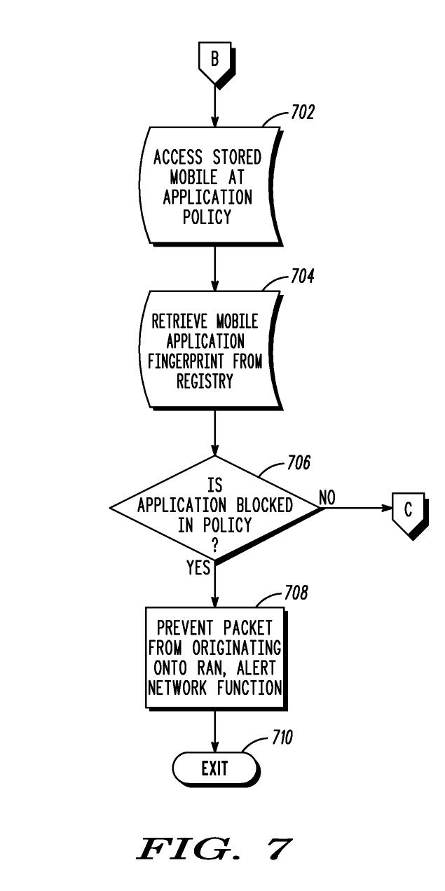

In another embodiment, the mobile resident security module 120, at step 510, determines that a user application is attempting to send IP packets to the network 102. The control flows to entry point B (application screening logic) of FIG. 7. In yet another embodiment, the mobile resident security module 120, at step 512, determines that a shutdown or termination is being initiated. The monitoring performed by the mobile resident security module 120, at step 514, is stopped and the control flows exits at step 514.

At step 602, the mobile resident security module 120 determines that a user is attempting to add an application to the wireless device 104. The mobile resident security module 120, at step 604, informs the network resident security module 122 at the information processing system of the application addition attempt. The mobile resident security module 120, at step 606, determines if the network resident security module 122 at the information processing system has allowed the application addition. If the result of this determines is negative, the mobile resident security module 120, at step 608, informs the user that the application cannot be added and that a security violation has occurred. The control flow then exits at step 610.

If the result of this determination is positive, the mobile resident security module 120, at step 612, updates a registry with the new application fingerprint. The following is a brief discussion of an application fingerprint. When an end user attempts to add an application to the wireless device, the mobile resident security module 120 applies an algorithm designed to provide a result which uniquely identifies that application among all others that may be executed. This fingerprint value can be stored in a secure area of memory (registry) within the wireless device 104. This secure area can not be accessed by other applications so as to preserve the integrity of the data included therein.

When the end user attempts to add or install an application onto the wireless handset, allowing it to be executed by the end user, the wireless device 104 notifies the mobile resident security module 120. The security module 120 looks up the fingerprint included in the fingerprint registry, and compares to the security policy transferred to the device from the network resident security module 122. In one embodiment, the mobile resident security module 120 provides instruction to the wireless handset whether the application addition or installation is allowed by policy. This decision point is based on the comparison result of the fingerprint generated by the mobile resident security module 120, versus the contents of the security policy. The result of the comparison (positive or negative result) is compared to the instructions stored within the security policy on if installation is to be allowed based on a positive or negative result. Based on this determination, the mobile resident security module 120 notifies the wireless device 104 to proceed with the application addition or installation, or to abort.

In another embodiment, the network resident security module 122 has access to a registry including a number of fingerprints for applications to be screened for execution of the wireless device 104. When the network resident security module 122 queues security policy updates for distribution to the mobile devices, the security function collects the fingerprints from the registry (plus stored instructions set by the operator for allowing or disallowing application execution based on a fingerprint comparison); generates a security policy based on this logic; and queues the resultant file for transmission.

The mobile resident security module 120, at step 614, informs the user that the application has been added. The control flow then exits at step 616. In another embodiment, the mobile resident security module 120, at step 618, determines that a user is attempting to remove an application from the wireless device 104. The mobile resident security module 120, at step 620, removes the application fingerprint from the registry. The control flow then exits at step 622.

Process of Screening Application Events Via the Wireless Device Security Module

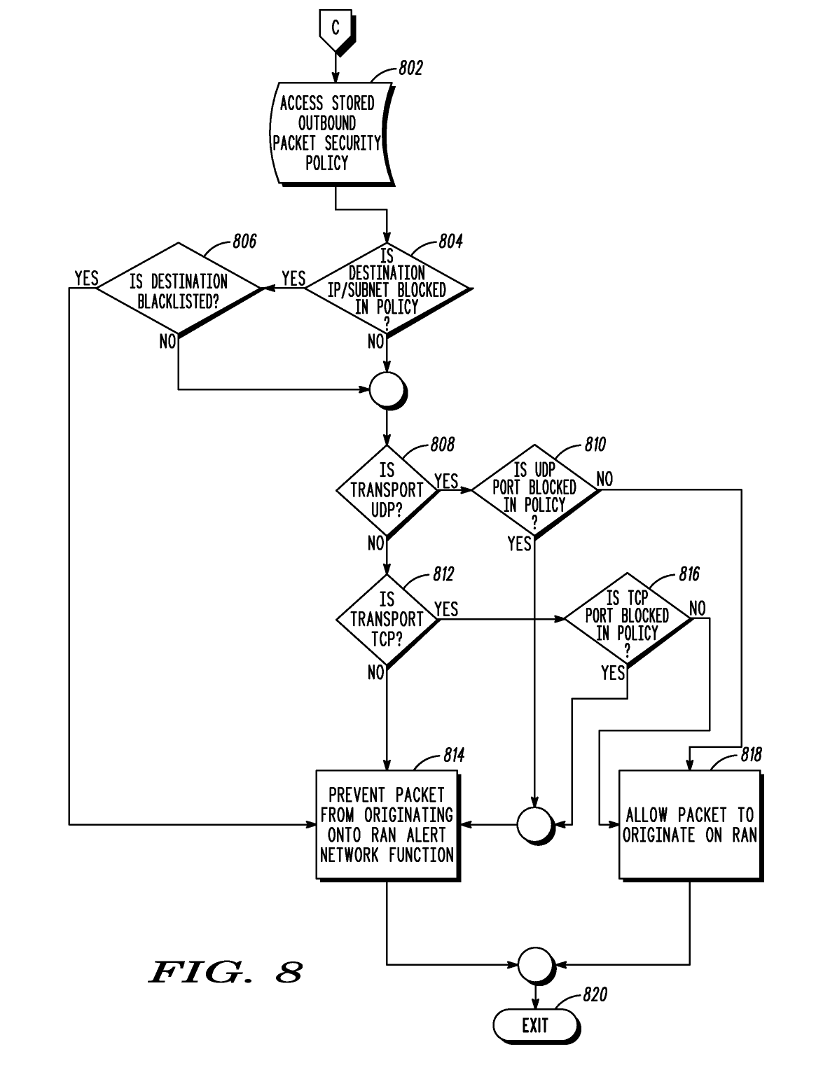

FIG. 7 is an operational flow diagram illustrating a process of screening application events via the mobile resident security module 120 at the wireless device 104. In particular, FIG. 7 illustrates the logic for allowing or disallowing an application to execute on the wireless device 104. The control flow of FIG. 7 enters at entry point B and flows directly to step 702. The security module 120, at step 702, accesses one or more security policies 126 at the wireless device 104 in response to determining that an application is attempting to send IP packets to the network 102. The security module 120, at step 704, retrieves the application fingerprint from the registry. The mobile resident security module 120, at step 706, determines based on the security polity 126 if the application is blocked from sending IP packets. If the result of this determination is negative the control flows to entry point C of FIG. 8. If the result of this determination is positive, the security module 120, at step 708, prevents the packet from originating on the network 102 and notifies the network resident security module 122 at the information processing system. The control flow then exits at step 710.

Process of Screening Packets Via the Wireless Device Security Module

FIG. 8 is an operational flow diagram illustrating a process of screening packets originating at the wireless device 104 the mobile resident security module 120 at the wireless device 104. In particular, FIG. 8 shows screening logic for applications that have been cleared to originate traffic onto the radio access network via an application security policy. This logic limits the type of traffic that the application can originate by using the internet protocol destination address, transport type, remote application port values, and the like included in the internet protocol packet itself.

The control flow of FIG. 8 enters at entry point B and flows directly to step 802. The mobile resident security module 120, at step 802, accesses the security policy(s) 126 for outbound packets. The mobile resident security module 120, at step 804, determines if the destination IP/subnet is blocked in the accessed policy 126. If the result of this determination is positive, the mobile resident security module 120, at step 806, determines if the destination is blacklisted. If the result of this determination is positive, the mobile resident security module 120, at step 814, prevents the packet from originating onto the network 102 and notifies the network resident security module 122 at the information processing system 106. If the result of this determination is negative, the control flows to step 808.

If the determination at step 804 is negative, the mobile resident security module 120, at step 808, determines if the transport is UPD. If the result of this determination is positive, the mobile resident security module 120, at step 810, determines if the UDP port is blocked in the accessed policy 126. If the result of this determination is positive, the control flows to step 814 where the mobile resident security module 120 prevents the packet from originating onto the network 102 and notifies the network resident security module 122 at the information processing system 106. The control flow then exits at step 820. If the result of the determination at step 810 is negative, the mobile resident security module 120, at step 818, allows the packet to originate on the network 102. The control flow then exits at step 820.

If the result of the determination at step 808 is negative, the mobile resident security module 120, at step 812 determines if the transport is TCP. If the result of this determination is negative, the mobile resident security module 120, at step 814, prevents the packet from originating onto the network 102 and notifies the network resident security module 122. The control flow then exits at step 820. If the result of this determination is positive, the mobile resident security module 120, at step 816, determines if the TCP port is blocked in the accessed policy 816. If the result of this determination is positive, the mobile resident security module 120, at step 814, prevents the packet from originating onto the network 102 and notifies the network resident security module 122. If the result of this determination is negative, the mobile resident security module 120, at step 818, allows the packet to originate on the network 102. The control flow then exits at step 820.

Process of Initializing the Security Module on Service Provider Side

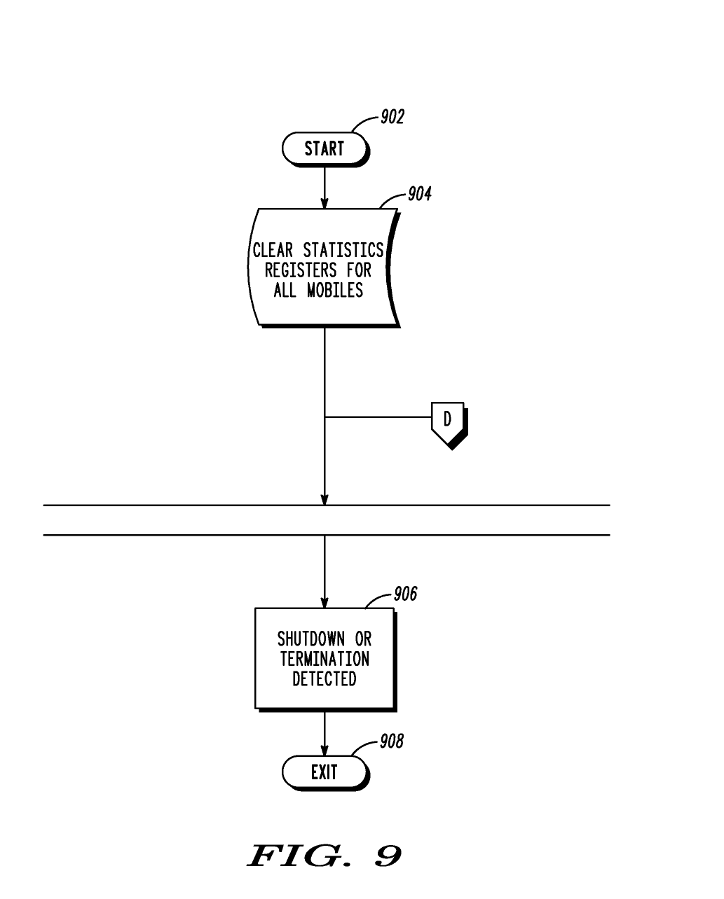

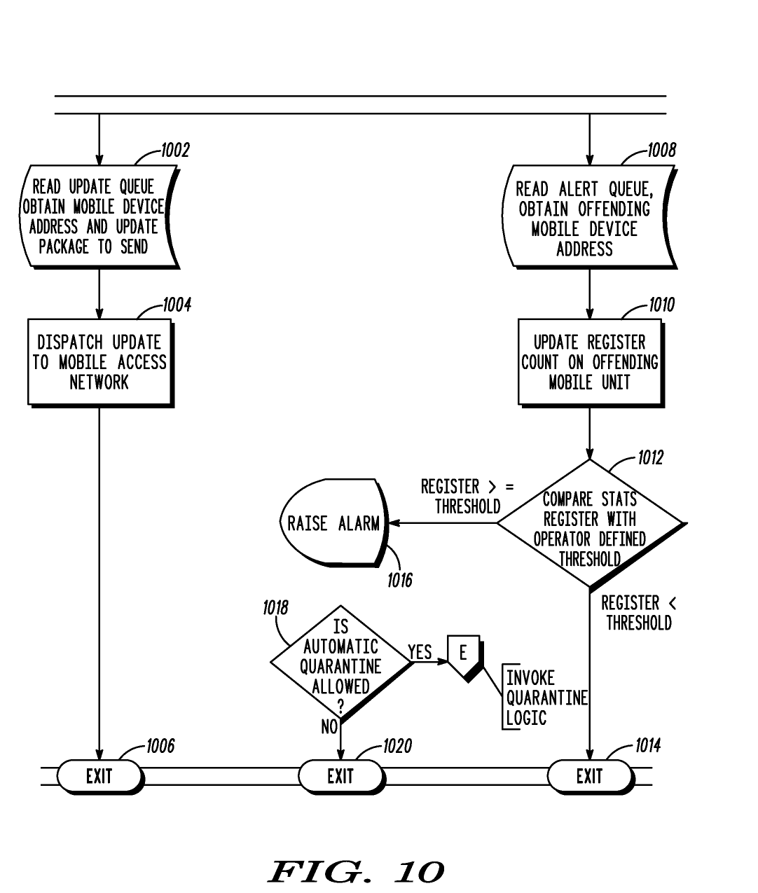

FIG. 9 is an operational flow diagram illustrating a process of initializing the network resident security module 122 residing at the information processing system 106. The operational flow diagram of FIG. 9 begins at step 902 and flows directly to step 904. The network resident security module 122 at the information processing system, at step 904, clears statistic registers for all of the wireless devices subscribed to the network 102. The control flows to entry point D of FIG. 10. If the network resident security module 122, at step 906, determines that a shutdown of termination has been initialized, the control flow exits at step 908.

Process of Processing Events Via the Security Module on Service Provider Side

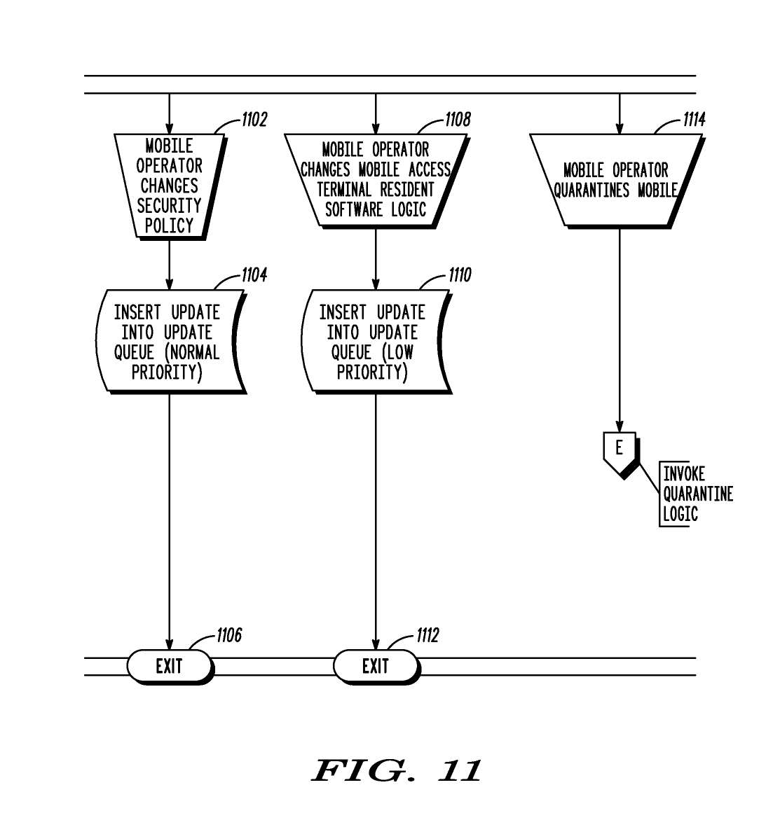

FIGS. 10 and 11 are operational flow diagrams illustrating a process of managing security events via the network resident security module 122 residing at the information processing system 106. In particular, the network resident security module 122 reacts to the mobile telephone network operator initiating changes to security policies; initiating mobile network resident function updates to remote handsets; and monitoring the inbound message queue from the mobile telephone network for offending mobiles. In one typical embodiment of this invention, the network resident security module 122 supervises wireless devices whose resident security modules 120 report repeated policy violations.

The control flow of FIG. 10 enters at entry point D and flows directly to step 1002, 1008, 1102, 1108, or 1114. The network resident security module 122, at step 1002, determines that an update is to be sent to the mobile resident security module 120 and reads an update queue, obtains the address of the wireless device 104 and retrieves that update package to be sent to the wireless device 104. The network resident security module 122, at step 1004, dispatches the update to the wireless device 104. The control flow then exits at step 1006.

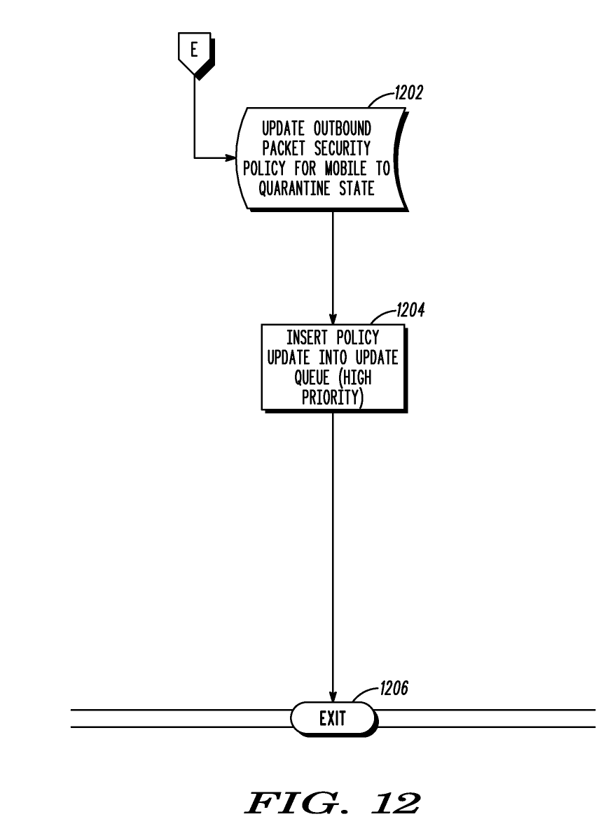

The network resident security module 122, at step 1008, detects that a wireless device 104 has violated a security policy and reads an alert queue and obtains the address of the violating wireless device. The network resident security module 122, at step 1010, updates a register count on the offending wireless device 104. The network resident security module 122, at step 1012, compares the statistics register with an operator defined threshold, e.g., a policy violation threshold. If the register is greater than or equal to the threshold, the network resident security module 122, at step 1016, raises an alarm. The network resident security module 122, at step 1018, determines if automatic quarantine is allowed. If the result of this determination is negative, the control flow exits at step 1020. If the result of this determination is positive, the control flows to entry point E of FIG. 12. If the comparison at step 1012 indicates that the register is less than the threshold, the control flow then exits at step 1014.

A network operator/service provider at step, 1102, changes a security policy 124. The network resident security module 122, at step 1104, inserts the update into an update queue with normal priority. The control flow then exits at step 1106. The network resident security module 122, at step 1108, determines that the network operator/service provider has updated the mobile resident security module 120. The network resident security module 122, at step 1110, inserts the update into an update queue with low priority. The control flow then exits at step 1112. The network resident security module 122, at step 1114, determines that the network operator/service provider has quarantined the wireless device 104. The control flows to entry point E of FIG. 12.

Process of Quarantining a Wireless Device Via the Security Module on Service Provider Side

FIG. 12 is an operational flow diagram illustrating a process of quarantining a wireless device 104 via the network resident security module 122. Quarantining prevents packets the wireless device 104 from originating packets onto the network 102. The control flow of FIG. 12 enters at entry point E and flows directly to step 1202. The network resident security module 122, at step 1202, updates security policies 124 for outbound packets for the wireless device 104 to a quarantine state. The network resident security module 122, at step 1204, inserts the policy 126 into an update queue with a high priority. In one embodiment, a message can be displayed to the user of the wireless device 104 when the device is placed into a quarantined state. The control flow then exits at step 1204.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless communication device, for managing packet data transmissions, the method comprising:
receiving, from a service provider, a set of security policies;
receiving a request from an application to originate packet data;
analyzing, in response to receiving the request to originate packet data, the set of security policies provided by the service provider;
determining, in response to the analyzing, if the set of security policies allows the packet data to be transmitted;
wherein in response to the set of security policies allowing the packet data to be transmitted,
allowing the packet data to be transmitted onto a wireless network; and
wherein in response to the set of security policies not allowing the packet data to be transmitted,
preventing the packet data from being transmitted onto a wireless network.

2. The method of claim 1, wherein the packet data is Internet Protocol packet data.

3. The method of claim 1, further comprising:
notifying, in response to the packet data being prevented from being transmitted onto the wireless network, a security module residing on the wireless network of the prevented transmission of packet data.

4. The method of claim 1, wherein the set of security policies includes at least security policy for transmitting packet data and at least one security policy associated with a set of applications.

5. The method of claim 1, wherein the preventing further comprises:
analyzing a destination of the packet data; and
comparing the destination to the set of security policies.

6. The method of claim 1, further comprising:
receiving a user request to add an application;
analyzing, in response to receiving the user request, the set of security policies provided by the service provider;
determining, in response to the analyzing, if the set of security policies allows the application to be added;
wherein in response to the set of security policies allowing the application to be added,
allowing the application to be added; and
wherein in response to the set of security policies not allowing the application to be added,
preventing the application from being added.

7. The method of claim 6, further comprising:
notifying, in response to the application being prevented from being added, a security module residing on the wireless network of the prevented addition of the application.

8. The method of claim 6, wherein allowing the application to be added further comprises:
generating a unique identification associated with the application; and
storing the unique identification in a secure memory.

9. A wireless communication device for managing packet data transmissions, the wireless communication device comprising:
a memory;
a processor communicatively coupled to the memory;
a security module communicatively coupled to the memory and the processor, wherein the security module is adapted to:
receiving, from a service provider, a set of security policies;
receiving a request from an application to originate packet data;
analyzing, in response to receiving the request to originate packet data, the set of security policies provided by the service provider;
determining, in response to the analyzing, if the set of security policies allows the packet data to be transmitted;
wherein in response to the set of security policies allowing the packet data to be transmitted,
allowing the packet data to be transmitted onto a wireless network; and
wherein in response to the set of security policies not allowing the packet data to be transmitted,
preventing the packet data from being transmitted onto a wireless network.

10. The wireless communication device of claim 9, wherein the security module is further adapted to:
notifying, in response to the packet data being prevented from being transmitted onto the wireless network, a security module residing on the wireless network of the prevented transmission of packet data.

11. The wireless communication device of claim 9, wherein the set of security policies includes at least security policy for transmitting packet data and at least one security policy associated with a set of applications.

12. The wireless communication device of claim 9, wherein the preventing further comprises:
analyzing a destination of the packet data; and
comparing the destination to the set of security policies.

13. The wireless communication device of claim 9, wherein the security module is further adapted to:
receiving a user request to add an application;
analyzing, in response to receiving the user request, the set of security policies provided by the service provider;
determining, in response to the analyzing, if the set of security policies allows the application to be added;
wherein in response to the set of security policies allowing the application to be added,
allowing the application to be added; and
wherein in response to the set of security policies not allowing the application to be added,
preventing the application from being added.

14. The wireless communication device of claim 13, wherein the security module is further adapted to:
notifying, in response to the application being prevented from being added, a security module residing on the wireless network of the prevented addition of the application.

15. A wireless communications system for managing packet data transmissions, the wireless communications system comprising:
a plurality of base stations;
a plurality of wireless communication devices, wherein each wireless communication device is communicatively coupled to at least one base station, and wherein at least one wireless communication device includes a security module adapted to:
receiving, from a service provider, a set of security policies;
receiving a request from an application to originate packet data;
analyzing, in response to receiving the request to originate packet data, the set of security policies provided by the service provider;
determining, in response to the analyzing, if the set of security policies allows the packet data to be transmitted;
wherein in response to the set of security policies allowing the packet data to be transmitted,
allowing the packet data to be transmitted onto a wireless network; and
wherein in response to the set of security policies not allowing the packet data to be transmitted,
preventing the packet data from being transmitted onto a wireless network.

16. The wireless communications system of claim 15, wherein the security module is further adapted to:
notifying, in response to the packet data being prevented from being transmitted onto the wireless network, a security module residing on the wireless network of the prevented transmission of packet data.

17. The wireless communications system of claim 15, wherein the set of security policies includes at least security policy for transmitting packet data and at least one security policy associated with a set of applications.

18. The wireless communications system of claim 15, wherein the preventing further comprises:
analyzing a destination of the packet data; and
comparing the destination to the set of security policies.

19. The wireless communications system of claim 15, wherein the security module is further adapted to:
receiving a user request to add an application;
analyzing, in response to receiving the user request, the set of security policies provided by the service provider;
determining, in response to the analyzing, if the set of security policies allows the application to be added;
wherein in response to the set of security policies allowing the application to be added,
allowing the application to be added; and
wherein in response to the set of security policies not allowing the application to be added,
preventing the application from being added.

20. The wireless communications system of claim 19, wherein the security module is further adapted to:
notifying, in response to the application being prevented from being added, a security module residing on the wireless network of the prevented addition of the application.
